(19) United States
(12) Patent Application Publication
(10) Pub. No.: US 2009/0097563 A1
(43) Pub. Date: Apr. 16, 2009

(54) METHOD AND APPARATUS FOR HANDLING VIDEO COMMUNICATION ERRORS

(75) Inventors: Stephen F. Brown, West Ryde (AU); Marwan A. Jabri, Broadway (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dilithium Networks Pty Limited, Broadway (AU)

(21) Appl. No.: 12/332,593

(22) Filed: Dec. 11, 2008

Related U.S. Application Data
(63) Continuation of application No. 10/762,829, filed on Jan. 21, 2004.
(60) Provisional application No. 60/479,226, filed on Jun. 16, 2003.

(51) Int. Cl. H04N 7/26

(52) U.S. Cl. 375/240.16; 375/240.12; 375/E07.123

(57) ABSTRACT

A method for handling video bitstream errors in a multimedia gateway device wherein a gateway device detects errors in the incoming video bitstream and sends a signal to the originating device to refresh the bitstream without need of error detection from an end terminating device. When the terminating device signals for the video bitstream to be refreshed, the gateway locally generates and transmits an appropriate refresh frame. The invention allows the gateway to handle errors for devices such as streaming and message servers that have no built-in error handling.

### CROSS-REFERENCES TO RELATED APPLICATIONS

This application is a continuation of U.S. patent application Ser. No. 10/762,829 (Attorney Docket Number 021318-00241 OUS) titled “Method and Apparatus for Handling Video Communication Errors” filed Jan. 21, 2004, which application claims priority to U.S. Provisional Patent Application No. 60/479,226 (Attorney Docket Number 021318-002400US) titled “Transrating Video Transcoder” filed Jun. 16, 2003, the contents of which are incorporated by reference herein for all purposes.

### BACKGROUND OF THE INVENTION

The present invention relates generally to processing telecommunication signals. There are several standards for coding audio and video signals across a communications link. These standards allow terminals (handsets, desktops, gateways, etc.) to interoperate with other terminals that support the same sets of standards. Terminals that do not support a common standard can only interoperate if an additional device, namely a transcoding gateway, is inserted between the devices. The transcoding gateway translates the coded signal from one standard to another. Multimedia gateways are transcoding gateways which in addition to transcoding may perform functions such as mediating the call signaling between terminals on different networks (mobile, packet landline, etc.), and the translation of command and control information between the protocols used by the terminals. In some applications, one of the terminals may be a server application (e.g., videomail answering service). The multimedia gateway may be a physically independent unit or may be a module within the server system. Transcoding gateways are referred to simply as multimedia gateways.

Terminals on different networks may also utilize identical media codecs (audio, video). However, the packing of the coded bits in frames transmitted over the communication channels may differ. For example, voice and video bitstreams are commonly transmitted over the packet networks by encapsulating their bit frames into Real Time Protocol (RTP) packets. The RTP packets include header information that contains information such as time stamps and sequence numbers. The media (voice, video, data) bits which consist of groups of the compressed bitstreams form the payloads of such RTP packets.

In contrast, on 3G videotelephony networks employing the H.324M/3G-324M standard, media bit chunks are multiplexed into the circuit switched bitstream.

Depending on the networks and underlying communication protocols used, the media bit chunks (payload) could have different rules governing the size and boundary at which these bit groups are formed by the codec and made ready for transmission in either RTP packets or multiplexed on a circuit switched channel.

Hence a multimedia gateway not only must deal with the transcoding between different coding standards when used by terminals, but also must validate and adjust the size and boundary of the bit groups in order to meet the framing requirements of the protocols used on those networks. Therefore, although no transcoding per-se may be involved when the same codecs are used by the terminals, the gateway needs to process the audio and video bitstreams to make them compliant from payload size and payload boundary perspectives.

A particular case of interest is an environment with a mobile videotelephony terminal (e.g. H.324M/3G-324M terminal). Mobile terminals make use of radio communication, and errors are often induced in the bitstreams because of interference or transmission/reception conditions. Audio and video corruptions are readily noticed by users. Excessive audio and video corruption can significantly degrade the user experience.

It is helpful to review some of the video compression principles.

Video data consists of a sequence of images. Each individual image is called a frame.

There are several methods used by hybrid video codecs for encoding (compressing) the information in a frame. The encoded frame types relevant to this invention are as follows:
I frames are coded as still images and can be decoded in isolation from other frames
P frames are coded as differences from the preceding I or P frame or frames to exploit similarities in the frames.
B frames are coded as differences from either preceding or following I or P frames to exploit similarities in the frames.

Predictive video coding (frames coded as P and B frames) is a key technique in modem video compression that allows an encoder to remove temporal redundancy in video sequences by compressing video frames utilizing information from previous frames.

The frames to be encoded are first broken into macroblocks. Macroblocks contain both luminance and chrominance components of a square region of the source frame. In the H.261, H.263 and MPEG video compression standards, source video frames are decomposed into macroblocks containing 16 by 16 luminance picture elements (pixels) and the associated chrominance pixels (8 by 8 pixels for 4:2:0 format source video).

The macroblocks are then further divided into blocks. Luminance and chrominance pixels are stored into separate blocks. The number and size of the blocks depend on the codec. H.261, H.263 and MPEG-4 compliant video codecs divide each macroblock into six 8 by 8 pixel blocks, four for luminance and two for chrominance.

Each block is encoded by first using a transform to remove spatial redundancy then quantizing the transform coefficients. This stage will be referred to as “transform coding”. The non-zero quantized transform coefficients are further encoded using run length and variable length coding. This second stage will be referred to as VLC encoding. The reverse processes will be referred to as VLC decoding and transform decoding, respectively. The H.261, H.263 and MPEG4 video compression standards use the discrete cosine transform (DCT) to remove spatial redundancy in blocks.

Macroblocks can be coded in three ways:
“Intra coded” macroblocks have the pixel values copied directly from the source frame being coded.
“Inter coded” macroblocks exploit temporal redundancy in the source frame sequence. Inter macroblocks have pixel values that are formed from the difference between pixel values in the current source frame and the pixel values in the reference frame. The reference frame is a previously decoded frame. The area of the reference frame used when computing the difference is controlled by a motion vector or vectors that specify the displacement between the macroblock in the current frame and its best match in the reference frame.
“Not coded” macroblocks are macroblocks that have not changed significantly from the previous frame and no motion or coefficient data is transmitted for these macroblocks

The types of macroblocks contained in a given frame depend on the frame type. For the frame types of interest to this algorithm, the allowed macroblock types are as follows;
I frames can contain only Intra coded macroblocks.
P frames can contain Intra, Inter and “Not Coded” macroblocks.

In some video codecs, macroblocks can be grouped into units known as “groups of blocks” or GOBs.

Video coding standards, such as H.261, H.263, H.264 and MPEG-4-video, describe the syntax and semantics of compressed video bitstreams. Errors in communication between the transmitting and receiving device will usually result in the video decoder in the receiver detecting syntax errors in the received bitstream. The corruption in the bitstream of a video frame not only affects the present picture being processed, but can also affect many subsequent video frames that are being encoded using predictive coding (P or B frames). Most video communication protocols use a command and control protocol that includes an error recovery scheme based on what is called “video-fast-update” request. This request signals to the side transmitting the video to encode the next video frame as an I-frame (encoding utilizing the content of the current video frame only). The video-fast-update technique limits any corruption to a very short period of time, desirably not noticeable by the user, allowing the video quality to be restored quickly.

Conventional design of multimedia gateways provides that the gateway relay the video-fast-update from the originating terminal to the other terminal (whether handset or a server application such as a videomail answering service). This process is shown in FIG. 1. A transmitting terminal 101 sends video data to a multimedia gateway 102 which processes the bitstream and transmits it to a receiving terminal 103. The prior art bitstream processing may involve actual transcoding or formatting when the same coding standard is used by both terminals When the receiving terminal 103 detects an error in the video bitstream it sends a video-fast-update request to the multimedia gateway 102 which retransmits the request to the originating terminal 101. This approach works well in certain cases, such as video-conferencing, where the two terminals are actively encoding/decoding the video streams and are capable of sending a video-fast-update when they detect corruption or when they are requested to do so.

Example scenarios where the conventional handling of bitstream errors may not be sufficient are described below.

Some video terminal equipment, such as messaging and streaming servers may not be able to detect errors in incoming video bitstreams (they may not decode the bitstream and simply store it, as is, compressed) or respond to video-fast-update requests because they may be transmitting an already encoded (compressed) bitstream and hence they are not actively encoding as to change their encoding mode to encode and transmit an I-Frame. For example, a messaging server such as video answering service that simply saves a videomail message in a mailbox in a compressed format and later replays the compressed video bitstream can neither detect bitstream errors nor respond to a video-fast-update request. In this case it is essential for the multimedia gateway to deal with the error conditions; otherwise the user will continue to see corrupt video until the next I-Frame in the message bitstream is transmitted. This can significantly degrade the user experience as the corruption can last for several seconds, and possibly 10 seconds, depending on the frequency of I-Frames in the compressed bitstream. Storing higher number of I-Frames in the bitstream may not alleviate the problem as I-Frame take more bitrate bandwidth than P-Frames and hence the actual frame rate of the video may be affected.

In the case of depositing a videomail message at a video-answering service, errors can be incurred on the air-interface as the mobile terminal is transmitting the video bitstream. If the multimedia gateway simply relays the bitstream without checking for errors, and the video-answering service records the bitstream without checking it, the corrupt video will be recorded.

What is needed are methods that allow multimedia gateways to deal with situations where errors are introduced in the video bitstream received or transmitted by a mobile terminal.

### SUMMARY OF THE INVENTION

According to the invention, methods are provided for handling video bitstream errors in a multimedia gateway device wherein a gateway device detects errors in the incoming video bitstream without relying on error detection at an end terminating device and sends a signal to the originating device to refresh the bitstream. When the terminating device signals for the video bitstream to be refreshed, the gateway locally generates and transmits an appropriate refresh frame. The video in a multimedia gateway is processed between any pair of hybrid video codecs over any connection protocol with the objective to enable the multimedia gateway to efficiently deal with video bitstream errors.

When the incoming video bitstream to the multimedia gateway is likely to have bit errors present, the apparatus includes modules to detect corruption and signal the transmitting terminal to recover from the corruption. The corruption may be detected when the data is first received and processed in a media independent layer, for example checksum errors or sequence number mismatch during demultiplexing, or by a decode module for the input codec which is capable of detecting errors in video bitstreams passing through the multimedia gateway. When errors are detected at the media independent level and the transport protocol supports retransmission, the transmitting terminal can be requested to resend the data. When retransmission requests are not available or desirable (since the retransmission procedure will incur delays and may lead to audio and video streams losing synchronization) and when errors are detected as video bitstream syntax errors, the gateway sends a video-fast-update request to the transmitting terminal.

A video decoder is required for the videomail server to check the video bitstream it receives. A command and control functionality coupled to the video decoding functionality is required for the videomail server to transmit a video-fast-update to request the transmitting handset to transmit an I-Frame. The invention introduces the functionality of checking the video bitstream for errors and the notification of the transmitter of a video-fast-update to be located in the multimedia gateway, even when the same video coding standard is used on either side of the gateway. This has several advantages as the gateway is typically equipped with much more real-time processing power than a server, and that the gateway is the closest network element to the transmitter and as a result the time taken for the handling of the errors can significantly shorter than the time for the errors to reach and to be processed by the videomail server. In addition, the multimedia gateway may also do video transcoding and hence the error handling could be incorporated in the transcoder.

When the video being transmitted by the gateway is likely to have bit errors introduced in the channel between the multimedia gateway and receiver, the apparatus includes a decode module for the input codec and an encode module for the output codec. When the multimedia gateway receives a video-fast-update request, the encode module is capable of converting the output of the decode module to an I-frame, regardless of the frame coding type of the decoded frame.

The present invention allows a gateway to process locally the “video-fast-update” requests leading to minimal video corruption and better user experience. The local processing of the “video-fast-update” requires the video processing in the multimedia gateway to be capable of transmitting an I-Frame in response to the video-fast-update request. This local processing can be done in several ways:

a) If the video processing performs a decoding and a re-encoding (a tandem transcoder), then the encoder of the video processor in the gateway can easily perform the video-fast-update request.

b) An alternative video processing method to implement local handling of the video-fast-update requests is to embed such processing in a smart video transcoding module. Such a transcoder operates on a macroblock by macroblock basis or a frame by frame basis. The video transcoding module is capable of dealing with the transcoding when:
i. The coding standard used by both terminals (e.g., user-end point and the messaging or content server) is the same. For example, the transcoder may decode the input bitstream but reuse the input bitstream unchanged when there is no error, only incurring the cost of encoding when required to generate an I-frame to service a video-fast-update request.
ii. The coding standard used by the terminals is different but similarities allow for a smart transcoding to be done. For example, the transcoder may decode and re-encode each frame but reuse information such as motion vectors and macroblock coding types in the encode stage. The transcoder in this case can be trivially extended to re-encode any frame as an I-frame in response to a video-fast-update request.

Local detection of the errors by the video gateway not only simplifies the function of the video-mail server (which typically is not geared for real-time bitstream processing dictated by 3G-324M), but also minimizes the duration of video corruption as the round-trip time will be longer if the video-fast-update requests must travel to the video-mail server and back. The detection of errors and the generation of video-fast-update locally in the multimedia gateway ultimately lead to a significant reduction in the exposure of the mailbox subscriber user to corruption in the video retrieved from the video-mail server. It also eliminates the need to incorporate video decoders in the video-mail servers.

The invention will be explained in greater detail with reference to the following detailed description in connection with the accompanying drawings.

### BRIEF DESCRIPTION OF THE DRAWINGS

FIG. 1 is a block diagram illustrating a conventional prior art multimedia gateway connection handling a video-fast-update request.

FIG. 2 is a flow chart of the error detection process in a multimedia gateway according to the invention where the received bitstream data may contain errors.

FIG. 3 is a block diagram illustrating a multimedia gateway connection from a first hybrid video codec to a second hybrid video codec according to the invention where there may be bit errors in the video data received at the gateway.

FIG. 4 is a block diagram illustrating a multimedia gateway connection from a first hybrid video codec to a second hybrid video codec according to the invention where the gateway may receive video-fast-update requests from the receiver.

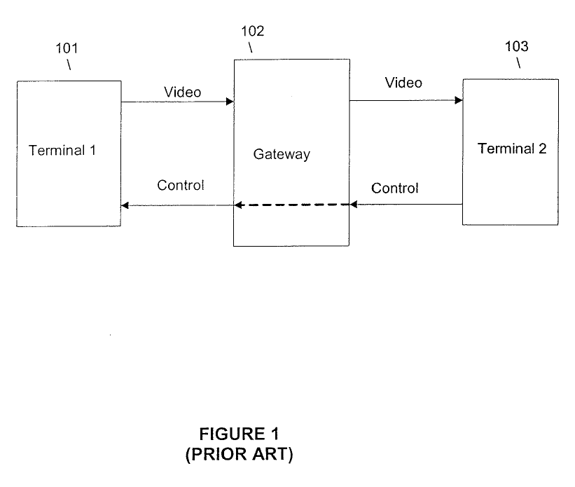

### DETAILED DESCRIPTION OF THE INVENTION

The invention is explained with reference to a specific embodiment. In the particular case of a multimedia gateway for H.324M/3G-324M (henceforth referred to as 3G-324M) to H.323 protocol translation and multimedia transcoding, the H.323 terminal may be a videomail answering service utilizing the H.323 protocol to communicate with the multimedia gateway or another type of server or an end user terminal. The 3G-324M and H.323 protocols are used here for illustrative purposes only. The methods described here are generic and apply to the processing of video in a multimedia gateway between virtually any pair of hybrid video codecs over virtually any connection protocol. A person skilled in the relevant art will recognize that other steps, configurations and arrangements can be used without departing from the spirit and scope of the present invention.

When a 3G-324M handset transmits its video over the air-interface, bit-errors can be incurred leading to information payloads being irreversibly corrupted. The apparatus of the invention detects the errors and can immediately, and without the intervention of the far-end receiving terminal (e.g. video-mail server), request the transmitting terminal to assist in the recovery from the error condition by performing a “video-fast-update”. The apparatus sends such requests either out-of-band (e.g. through an ITU-T H.245 message) or by an equivalent mean which may use an out-of-band or an in-band reverse channel. In the context of 3G-324M and H.323, the native H.245 messaging can be used as it is part of 3G-324M and H.323 and it provides facilities for the transmission of such messages.

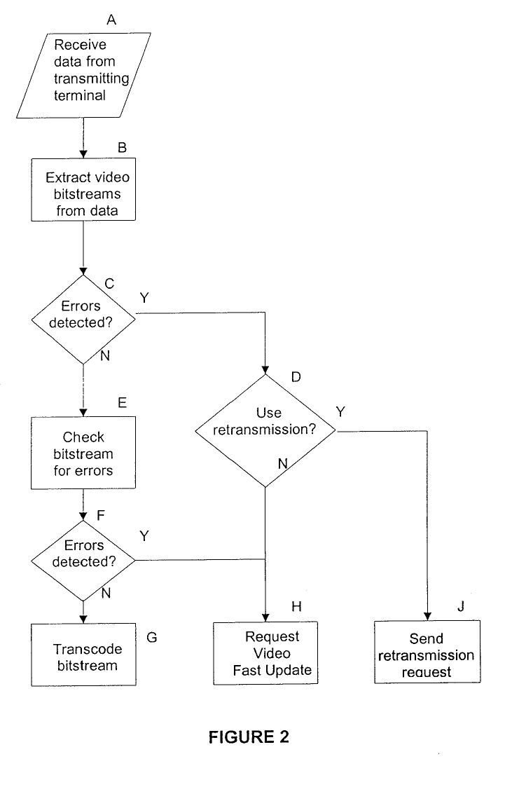

FIG. 2 is a flow chart of the error detection process in the preferred embodiment for a transcoding gateway where the bitstream data received at the gateway may contain bit errors. Data is received (Step A) from the transmitting terminal and the media bitstreams extracted (Step B) from the received data. The media present in the data may comprise multiple video and/or audio bitstreams. In the Figure, only a single video bitstream is illustrated for simplicity. If errors are detected during the bitstream extraction (Step C), and retransmission requests are operational and the gateway is configured to prefer them over Video Fast Updates (Step D), the gateway requests that the data be retransmitted (Step J). If retransmission is not supported or not preferred, the gateway will request a Video Fast Update (Step H). If no errors are detected during the bitstream extraction, the video bitstream is checked for errors (Step E). If errors are found in the bitstream (Step F), the gateway will request a Video Fast Update (Step H); otherwise, it will transcode the bitstream as usual (Step G).

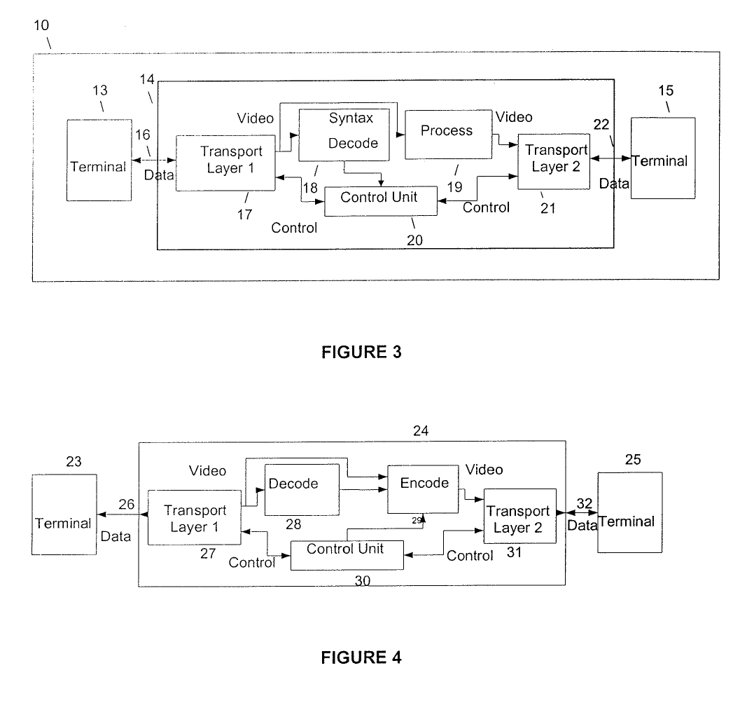

FIG. 3 is a block diagram of a specific embodiment for a transcoding gateway system 10 where the video bitstream received at the gateway 14 may contain bit errors. The Figure shows the video bitstream from 3G-324M terminal 13 as it passes through the gateway 14 before being sent to a H.323 terminal 15.

The incoming video bitstream on channel 16 is decoded by a transport layer interface 17. If the transport layer processing detects errors in the received bitstreams and retransmission requests are operational, the transport layer can send a retransmission request to the transmitting terminal 13.

The received video bitstream is passed to a syntax decode module 18. The syntax decode module 18 is responsible for checking the syntactical correctness of the bitstream. It does not have to fully decode the video bitstream.

When a bitstream error is detected by the syntax decode module 18, the error is signaled to a control module 20. The control module will generate a video-fast-update request which is transmitted back the 3G-324M terminal using the appropriate control protocol. When several errors are detected by module 18 in quick succession within a time window, the control module may choose to send only one video-fast-update request. The detection module 18, can be a simplified video decoder module which scans the video bitstreams but without reconstructing the video frames. This can be called syntax decoding in that the bitstream is scanned for errors and errors are reported to the control module 20. The error detection module can be implemented by a person skilled in the art.

The incoming video bitstream is also passed to a processing module 19. This module 19 performs the general transcoding task, for example, converting the input bitstream to a different video standard and/or changing the bitrate of the bitstream. If the input and output video standards are the same, the processing module 19 may simply pass the input to the output, making any changes to packet boundaries as required. If the processing requires that the incoming bitstream be decoded, such as a tandem transcoder, the processing 19 and syntax decoding modules 18 may be combined. When transcoding is desired, the most general design for the processing module 19 is a tandem transcoder. Such a module consists of a decoder of the incoming video standard whose output, in the form of uncompressed video frames, is used as input to an encoder of the outgoing video standard. The implementation of video decoders and encoders is a common task undertaken by signal processing engineers who do the implementations based on the encoder and decoder Standards published the corresponding standardization body. For example the H.263 is standardized by the International Telecommunication Union (ITU). The MPEG4 video codec is standardized by the International Standards Organization (ISO). Encoders, decoders and tandem transcoders can be implemented by a person skilled in the art.

The video data from the processing module 19 goes to a transport layer module 21 where it is combined with control and other media bitstreams. The data is then transmitted over the channel 22 to the receiving terminal 15.

When a 3G-324M terminal receives its video over the air-interface, bit-errors can be present leading to irreversibly corrupted information payloads. Bit errors during this message retrieval phase must be managed. During retrieval, a clean stored compressed video bitstream is transmitted by the video-mail or content server through the multimedia gateway, the MSC, to the terminal. The transmission from the MSC (through the radio-interface) may incur bit errors. The video bitstream on the message store of the video-mail server is most likely stored in a compressed format.

Uncompressed video requires a significant amount of storage space, and near-real-time compression is too computationally expensive to be performed on the video-mail server. If the video decoder in the terminal detects errors due to the radio-interface conditions, it will transmit a “video-fast-update” request to the transmitter. Because the video-mail server transmits pre-stored compressed bitstreams, it may not be capable of handling “video-fast-update” requests which require real-time encoding/response of uncompressed video content.

The gateway is the appropriate stage for dealing with “video-fast-update” requests. The present invention allows a gateway to process locally the “video-fast-update” requests leading to minimal video corruption and better user experience.

FIG. 4 is a block diagram of a specific embodiment for transcoding gateway where the video bitstream transmitted by the gateway may contain bit errors. The diagram shows the video bitstream from a H.323 terminal 23 as it passes through a gateway 24 before being sent to a 3G-324M terminal 25.

The data over the incoming channel 26 is decoded by a transport layer interface 27. The media present in the data may comprise multiple video and/or audio bitstreams. In the Figure, only a single video bitstream is shown for simplicity.

The video bitstream is decoded by a decode module 28. The outgoing bitstream is generated by an encode module 29. When no video-fast-update has been requested, the encode module 29 may use either the output and/or intermediate results from the decode module to generate the transcoded bitstream. If the input and output video standards are the same, the encoder 29 may simply pass the input to the output, possibly breaking the bitstream into packets with appropriate size and alignment for the outgoing transport standard.

When the control module 30 of the gateway 24 receives a video-fast-update from the 3G-324M terminal, it signals to the encoder 29 to encode the next frame as an I-frame. The encoder 29 uses the output from the decoder 28 as input in this case.

The data from the video encoder 29 goes to a transport layer module 31 where it is combined with control and other media bitstreams. The data is then transmitted over the channel 32 to the receiving terminal 25.

The local processing of the “video-fast-update” requires the video processing in the gateway to be capable of transmitting an I-Frame in response to the video-fast-update request. This local processing can be done in many ways:

a) If the video processing performs a decoding and a re-encoding (in a tandem transcoder), then the encoder of the video processor in the gateway can easily perform the video-fast-update request. The video decoder in the tandem transcoder functions as the decode module 28, and the encoder as the encode module 29. The control module 30 signals to the video encoder 29 to encode the next frame as an I frame. Executing a complete decode/re-encode is not the optimal technique to implement the local video-fast-update processing, since for example it requires significant processing power.

b) An alternative video processing fast update procedure embeds video processing in a smart video transcoding module. Such a transcoder can operate on a macroblock by macroblock basis or a frame by frame basis. The video transcoding module would be capable of dealing with the transcoding when:
i. The coding standard used by both terminals (e.g., user-end point and the messaging or content server) are the same. For example, the transcoder must decode the input bitstream, but it may reuse the input bitstream unchanged when there is no error, only incurring the cost of re-encoding the decoded video frames when required to generate an I-frame to service a video-fast-update request. When required to generate an I-frame, the transcoder passes the decoded frame data to the encoder to be recoded as intra macroblocks in an I frame.
ii. The coding standard used by the terminals is different, but similarities allow for smart transcoding. For example, the transcoder may decode and re-encode each frame but re-use information such as motion vectors and macroblock coding types in the encode stage. As in the previous case, when required to generate an I-frame, the transcoder passes the decoded frame data to the encoder to be recoded as intra macroblocks in an I-frame.

The invention has been explained with reference to specific embodiments. Other embodiments will be evident to those of ordinary skill in the art. It is therefore not intended that the invention be limited, except as indicated by the appended claims.

What is claimed is:

1. A method for converting a first coded video bitstream coded using a first video codec to a second coded video bitstream coded using a second video codec, the method being performed using an intermediate device coupled to a first device and a second device through one or more telecommunications networks, the method comprising:
a. decoding the first coded video bitstream in a video bitstream decoder disposed in a data path ahead of the second device;
b. receiving a video update request at the intermediate device from a device external to the intermediate device; and
c. re-encoding a plurality of macroblocks in a video bitstream encoder to form a plurality of re-encoded macroblocks, wherein each of the plurality of macroblocks is re-encoded as an intra coded macroblock upon receipt of the video update request.

2. The method of claim 1 wherein the video update request is received from the second device.

3. The method of claim 2 wherein the video update request is transmitted from the second device to the intermediate device in response to bit errors detected at the second device.

4. The method of claim 2 wherein the second device is a 3G-324M terminal.

5. The method of claim 2 wherein the second device is a terminal utilizing RTP.

6. The method of claim 2 wherein the intermediate device is a device utilizing a streaming protocol.

7. The method of claim 2 wherein the intermediate device is a device utilizing a connection-oriented protocol.

8. The method of claim 1 wherein the video bitstream encoder performs a portion of the re-encoding by reusing information obtained from the first coded video bitstream.

9. The method of claim 8 wherein the information obtained from the first coded video bitstream comprises at least one of one or more motion vectors or one or more macroblock encoding types.

10. The method of claim 1 wherein the plurality of macroblocks are a plurality of inter coded macroblocks.

11. The method of claim 1 wherein the video bitstream decoder is operative to manipulate data in a frequency transform domain.

12. The method of claim 1 wherein a first standard for the first video codec is the same as a second standard for the second video codec.

13. The method of claim 1 wherein a portion of the first coded video bitstream is copied to the second coded video bitstream, prior to receipt of the video update request.

14. The method of claim 1 wherein the each of the plurality of re-encoded macroblocks forms an entirety of an intra coded frame.

15. The method of claim 1 further comprising:
re-encoding a further plurality of macroblocks, wherein each of the further plurality of macroblocks is re-encoded as an inter coded macroblock in a frame following a frame containing the plurality of macroblocks.

16. The method of claim 1 wherein the second video codec is selected from the group consisting of H.261, H.263, H.264 and MPEG-4-video.

17. The method of claim 1 wherein a portion of the first coded video bitstream is pre-encoded to provide a pre-encoded video bitstream.

18. The method of claim 17 wherein the pre-encoded video bitstream is stored on a server.

19. The method of claim 1 further comprising transmitting an additional video update request to the first device upon receipt of the video update request.

20. The method of claim 1 wherein the video update request message is an H.245 VideoFastUpdate message.

21. The method of claim 1 wherein the video update request is a signal received from a second control module in the intermediate device.

22. The method of claim 1 wherein the video update request is a video-fast-update request.

23. An intermediate device coupled to a first device and a second device through one or more telecommunications networks and configured to convert a first coded video bitstream coded using a first video codec to a second coded video bitstream coded using a second video codec, the intermediate device comprising:
a. a video bitstream decoder disposed in a data path ahead of the second device and operative to decode the first coded video bitstream;
b. a video bitstream encoder coupled to the video bitstream decoder for re-encoding a plurality of macroblocks, wherein each of the plurality of macroblocks is re-encoded as an intra coded macroblock upon receipt of a video update request at the intermediate device from a device external to the intermediate device;
c. a control unit coupled to the encoder; and
d. a control port coupled to the control unit and configured to receive one or more control signals from the second device.

24. The intermediate device of claim 23 wherein the video update request is received at the control port.

25. The intermediate device of claim 23 wherein the video update request is received from the second device.

26. The intermediate device of claim 25 wherein the second device is a 3G-324M terminal.

27. The intermediate device of claim 25 wherein the second device is a terminal utilizing RTP.

28. The intermediate device of claim 25 wherein the intermediate device is a device utilizing a streaming protocol.

29. The intermediate device of claim 25 wherein the intermediate device is a device utilizing a connection-oriented protocol.

30. The intermediate device of claim 23 wherein a first standard for the first video codec is the same as a second standard for the second video codec.

31. The intermediate device of claim 23 wherein the second device comprises a videotelephony terminal.

32. The intermediate device of claim 23 wherein the video bitstream decoder is operative to fully decode a frame before encoding an output frame.

33. The intermediate device of claim 23 wherein the second device is adapted to transmit the video update request from the second device to the intermediate device in response to bit errors detected at the second device.

34. The intermediate device of claim 23 wherein the intermediate device is further coupled to a server disposed in a second data path ahead of the video bitstream decoder, the server being operative to transmit a portion of the first coded video bitstream from an encoded video bitstream.

35. The intermediate device of claim 23 wherein the plurality of macroblocks are a plurality of inter coded macroblocks.

36. The intermediate device of claim 23 wherein the video update request is an H.245 VideoFastUpdate message.

37. The intermediate device of claim 34 wherein the server is adapted to store the encoded video bitstream at the server.

38. The intermediate device of claim 23 wherein the intermediate device comprises a video gateway, wherein the video gateway is operative to interface between a first telecommunications network and a second telecommunications network different than the first telecommunications network.

39. The intermediate device of claim 23 wherein the intermediate device comprises a transcoding gateway, wherein the transcoding gateway is operative to interface between a first telecommunications network and a second telecommunications network different than the first telecommunications network.

40. The intermediate device of claim 23 wherein the first device is not operative to respond to a video-fast-update request.

41. The intermediate device of claim 23 is operative to copy a portion of the first coded video bitstream to the second coded video bitstream, prior to receipt of the video update request.

42. The intermediate device of claim 23 wherein the second video codec is selected from the group consisting of H.261, H.263, H.264, and MPEG-4-video.

43. The intermediate device of claim 23 is operative to handle multimedia signals.
